(19) United States
(12) Patent Application Publication
(10) Pub. No.: US 2026/0172081 A1
(43) Pub. Date: Jun. 18, 2026

(54) PRECODING CONFIGURATION METHOD AND APPARATUS

(71) Applicant: 1FINITY Inc., Kawasaki-shi (JP)

(72) Inventors: Guotong WANG, Beijing (CN); Xin WANG, Beijing (CN)

(73) Assignee: 1FINITY Inc., Kawasaki-shi (JP)

(21) Appl. No.: 19/534,087

(22) Filed: Feb. 9, 2026

Related U.S. Application Data
(63) Continuation of application No. PCT/CN2023/112390, filed on Aug. 10, 2023.

(51) Int. Cl. H04B 7/0456; H04W 72/232

(52) U.S. Cl. CPC H04B 7/0456; H04W 72/232

(57) ABSTRACT

A precoding configuration apparatus, configured in a terminal equipment capable of supporting an 8Tx uplink transmission, includes: a transmitter configured to report, to a network device, first information indicating the number of supported antenna groups and second information indicating whether a full power mode 1 is supported by the terminal equipment; and a receiver configured to receive, from the network device, precoding configuration information for indicating a precoder type which is determined by the network device according to the first information and the second information, and wherein the receiver is further configured to receive downlink control information including a transmission precoding matrix indication field indicating a value in one or more values which are indicated according to the precoding configuration information.

### CROSS-REFERENCE TO RELATED APPLICATION

This application is a continuation application under 35 U.S.C. 111(a) of International Patent Application PCT/CN2023/112390 filed on Aug. 10, 2023, and designated the U.S., the entire contents of which are incorporated herein by reference.

### TECHNICAL FIELD

Embodiments of this disclosure relate to the field of communication technologies.

### BACKGROUND

In the fifth generation (5G) mobile communication system or new radio (NR) mobile communication system, before Rel-18, a terminal equipment (such as UE) may support up to 4Tx for uplink transmission. The terminal equipment may be divided into a non-coherent UE, a partial coherent UE and a full coherent UE according to a coherent type of the terminal equipment.

On the other hand, Rel-16 introduces characteristics of uplink full power transmission that may increase an uplink transmission power of the terminal equipment supporting uplink MIMO. The uplink full power transmission includes a Mode 0, a Mode 1 and a Mode 2, which may be referred to a full power mode 0 (ul-FullPwrMode), a full power mode 1 (ul-FullPwrMode1), and a full power mode 2 (ul-FullPwrMode2).

It should be noted that the above introduction to the background is merely provided for clear and complete explanation of technical solutions of this disclosure and for easy understanding by those skilled in the art. And it should not be understood that these technical solutions are known to those skilled in the art only because they are described in the background of this disclosure.

### SUMMARY

The inventors found that a network device (such as gNB) could configure different precoders in correspondence to terminal equipments with different coherent types. For example, for a full coherent UE, the gNB may configure full coherent precoders, partial coherent precoders, and non-coherent precoders; for a partial coherent UE, the gNB may configure partial coherent precoders and non-coherent precoders; and for a non-coherent UE, the gNB may only configure non-coherent precoders.

In NR Rel-18, an uplink transmission of a terminal equipment may support 8Tx, meanwhile, a concept of antenna group is introduced. The number of antenna groups (Ng) supported by different coherent types is different. For a full coherent UE, Ng=1. For a partial coherent UE, one case is that the UE has two antenna groups, Ng=2; the other case is that the UE has four antenna groups, Ng=4. For a non-coherent UE, Ng=8. For full coherent precoders, Ng=1; for partial coherent precoders, Ng=2 or Ng=4; and for non-coherent precoders, Ng=8, accordingly.

The terminal equipment may report one or more supported Ng values, and the network device configures respective precoders according to capability reported by the terminal equipment. However, there is currently no clear solution for which Ng values the terminal equipment can specifically report for different coherent types. In addition, for a full power mode 1, a non-coherent UE and a partial coherent UE need to be configured with full coherent precoders for full power transmission. At present, the case of the full power mode 1 is not considered. In this case, there is no clear solution for how the terminal equipment reports supported Ng values and how the network device configures precoders.

In view of at least one of the above problems, embodiments of this disclosure provide a precoding configuration method and apparatus.

According to one aspect of embodiments of this disclosure, there is provided a precoding configuration method applied to a terminal equipment capable of supporting a 8-transmission (8Tx) uplink transmission, including:
reporting, by the terminal equipment, the number of supported antenna groups to a network device according to a coherent type and/or whether a full power mode 1 is supported; and
receiving, by the terminal equipment, precoding configuration information from the network device.

According to another aspect of embodiments of this disclosure, there is provided a precoding configuration apparatus configured in a terminal equipment capable of supporting a 8-transmission (8Tx) uplink transmission, including:
a transmitting unit configured to report the number of supported antenna groups to a network device according to a coherent type and/or whether a full power mode 1 is supported; and
a receiving unit configured to receive precoding configuration information from the network device.

According to another aspect of embodiments of this disclosure, there is provided a precoding configuration method applied to a network device, including:
receiving, by the network device, the number of antenna groups supported by a terminal equipment and reported by the terminal equipment, wherein the terminal equipment reports the number of antenna groups according to a coherent type and/or whether a full power mode 1 is supported; and
transmitting, by the network device, precoding configuration information to the terminal equipment according to the number of antenna groups supported by the terminal equipment and/or whether the terminal equipment supports the full power mode 1.

According to another aspect of the embodiments of this disclosure, there is provided a precoding configuration apparatus configured in a network device, including:
a receiving unit configured to receive the number of antenna groups supported by a terminal equipment reported by the terminal equipment, wherein the terminal equipment reports the number of antenna groups according to a coherent type and/or whether a full power mode 1 is supported;
and a transmitting unit configured to transmit precoding configuration information to the terminal equipment according to the number of antenna groups supported by the terminal equipment and/or whether the terminal equipment supports the full power mode 1.

According to another aspect of the embodiments of this disclosure, there is provided a communication system, including:
a terminal equipment, capable of supporting an 8-transmission (8Tx) uplink transmission, configured to report the number of supported antenna groups to a network device according to a coherent type and/or whether a full power mode 1 is supported; and a network device configured to transmit precoding configuration information to the terminal equipment according to the number of antenna groups supported by the terminal equipment and/or whether the terminal equipment supports the full power mode 1.

One of advantageous effects of embodiments of this disclosure is that for terminal equipments with different coherent types and/or whether the full power mode 1 is supported, the number of antenna groups reported by the terminal equipment and precoders configured by the network device are clearly specified.

With reference to the following description and drawings, the particular embodiments of this disclosure are disclosed in detail, and the manners in which the principle of this disclosure can be used are indicated. It should be understood that the scope of the embodiments of this disclosure is not limited thereto. The embodiments of this disclosure contain a plurality of alternations, amendments and equivalents within clauses of the appended claims.

Features that are described and/or illustrated with respect to one embodiment may be used in a same way or in a similar way in one or more other embodiments and/or in combination with or instead of the features of the other embodiments.

It should be emphasized that the term “comprise/include” when used herein refers to the presence of features, integers, steps or components but does not preclude the presence or addition of one or more other features, integers, steps, or components.

### BRIEF DESCRIPTION OF THE DRAWINGS

Elements and features depicted in one drawing or embodiment of this disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram illustrating a communication system according to an embodiment of this disclosure;

FIG. 2 is a schematic diagram illustrating a precoding configuration method according to an embodiment of this disclosure;

FIG. 3 is another schematic diagram illustrating a precoding configuration method according to an embodiment of this disclosure;

FIG. 4 is a schematic diagram illustrating a precoding configuration apparatus according to an embodiment of this disclosure;

FIG. 5 is another schematic diagram illustrating a precoding configuration apparatus according to an embodiment of this disclosure;

FIG. 6 is a schematic diagram illustrating a network device according to an embodiment of this disclosure; and

FIG. 7 is a schematic diagram illustrating a terminal equipment according to an embodiment of this disclosure.

### DETAILED DESCRIPTION

These and further features of this disclosure will be apparent with reference to the following description and drawings. In the description and drawings, particular embodiments of the disclosure have been disclosed in detail as being indicative of some of the embodiments in which the principles of the disclosure may be employed, but it should be understood that this disclosure is not limited to the embodiments described herein. Rather, this disclosure includes all alternations, amendments and equivalents falling within the scope of the appended claims.

In embodiments of this disclosure, terms “first”, “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include”, “have” refer to presence of stated features, elements, components, or assemblies, but do not exclude presence or addition of one or more other features, elements, components, or assemblies.

In embodiments of this disclosure, singular forms “a”, “the”, etc., include plural forms, and should be understood as “a kind of” or “a type of” in a broad sense, but should not be limited to a meaning of “one”; and the term “the” should be understood as including both a singular form and a plural form, except clearly specified otherwise. Furthermore, the term “according to” should be understood as “at least partially according to”, the term “based on” should be understood as “at least partially based on”, except clearly specified otherwise.

In embodiments of this disclosure, the term “communication network” or “wireless communication network” may refer to a network satisfying any one of communication standards, such as Long Term Evolution (LTE), Long Term Evolution-Advanced (LTE-A), Wideband Code Division Multiple Access (WCDMA), and High-Speed Packet Access (HSPA), etc.

Furthermore, communication between devices in a communication system may be performed according to communication protocols at any stage, which may, for example, include but not limited to the communication protocols: 1G (generation), 2G, 2.5G, 2.75G, 3G, 4G, 4.5G, and 5G, New Radio (NR) and 6G in the future, etc., and/or other communication protocols that are currently known or will be developed in the future.

In embodiments of this disclosure, the term “network device”, for example, refers to a device in a communication system that accesses terminal equipment to a communication network and provides services for the terminal equipment. The network device may include but not limited to devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), an IAB host, etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographic area. And a term “cell” may refer to a base station and/or its coverage area, depending on a context in which the term is used.

In embodiments of this disclosure, the term “user equipment” (UE) or “terminal equipment or terminal device” (TE) refers to, for example, equipment accessing to a communication network and receiving network services via a network device. The terminal equipment may be fixed or mobile, and may also be referred to as a mobile station (MS), a terminal, a subscriber station (SS), an access terminal (AT), a station, etc.

The terminal equipment may include but not limited to devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipment described above. “A device” in this text may refer to a network device, and may also refer to a terminal equipment, except otherwise specified.

A scenario of an embodiment in this disclosure shall be described below by way of examples. However, this disclosure is not limited thereto.

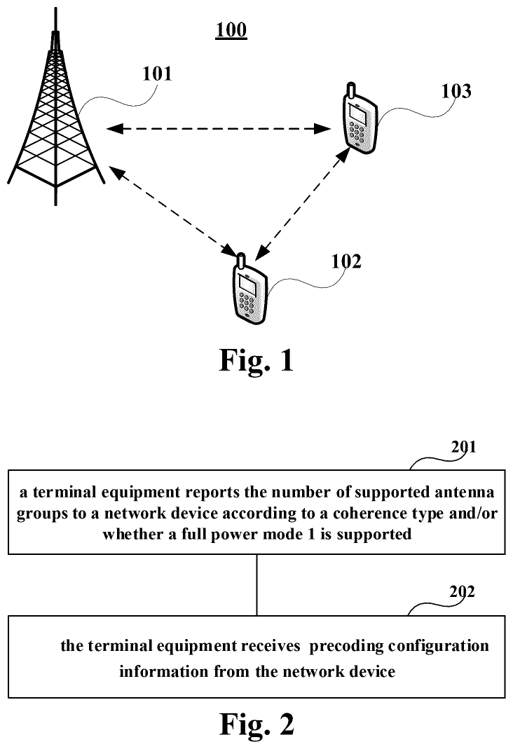

FIG. 1 is a schematic diagram illustrating a communication system according to an embodiment of this disclosure, which schematically illustrates a situation in which a terminal equipment and a network device are used as an example. As illustrated in the FIG. 1, a communication system 100 may include a network device 101 and terminal equipments 102 and 103. For the sake of simplicity, the FIG. 1 only illustrates two terminal equipments and one network device as an example, however, the embodiments of this disclosure are not limited thereto.

In embodiments of this disclosure, existing services or services that may be implemented in the future may be transmitted between the network device 101 and the terminal equipments 102 and 103. For example, these services may include but are not limited to: an enhanced Mobile Broadband (eMBB), a massive Machine Type Communication (mMTC), and an Ultra-Reliable and Low Latency Communication (URLLC), etc.

It should be noted that the FIG. 1 illustrates that both the terminal equipments 102 and 103 fall within a coverage of the network device 101, however, this disclosure is not limited thereto. Both the terminal equipments 102 and 103 may not fall within the coverage of the network device 101, or one terminal equipment 102 falls within the coverage of the network device 101 and the other terminal equipment 103 falls out of the coverage of the network device 101.

In embodiments of this disclosure, a higher layer signaling may be, for example, a radio resource control (RRC) signaling; for example, an RRC message, including, for example, a MIB, system information, a dedicated RRC message; or an RRC IE (RRC information element). The higher layer signaling may also be, for example, a MAC (Medium Access Control) signaling; or a MAC CE (MAC control element). However, this disclosure is not limited thereto.

In the description below, in a case where there exists no confusion, the terms “PDCCH” and “physical downlink control channel” or “downlink control information” may be interchangeable, and the terms “PDSCH” and “physical downlink data channel” or “downlink data” may also be interchangeable. In addition, transmitting or receiving the PDCCH may be understood as transmitting or receiving downlink control information carried by the PDCCH; transmitting or receiving the PDSCH may be understood as transmitting or receiving downlink data carried by the PDSCH.

### Embodiments of a First Aspect

The embodiments of this disclosure provide a precoding configuration method described from a terminal equipment side that is capable of supporting an 8-transmission (8Tx) uplink transmission. FIG. 2 is a schematic diagram illustrating a precoding configuration method according to an embodiment of this disclosure. As illustrated in the FIG. 2, the method includes:
201: a terminal equipment reports the number of supported antenna groups to a network device according to a coherent type and/or whether a full power mode 1 is supported; and
202: the terminal equipment receives precoding configuration information from the network device.

It should be noted that the FIG. 2 only schematically illustrates embodiments of this disclosure, however, this disclosure is not limited thereto. For example, an order of execution of operations may be appropriately adjusted, and some other operations may be added, or some operations therein may be removed. And appropriate variants may be made by those skilled in the art according to the above content, without being limited to the disclosure illustrated in the FIG. 2.

In some embodiments, the terminal equipment may report the number of supported antenna groups Ng to the network device by using UE capability information; and the network device may configure precoders for the terminal equipment by using configuration (e.g., by using RRC signaling) according to the UE capability information.

In some embodiments, for an 8Tx terminal equipment, the number of supported antenna groups (Ng) depends on a coherent type and capability of the terminal equipment.

For example, for a terminal equipment with the coherent type being a full coherence, the terminal equipment at least supports the number Ng of antenna groups to be equal to 1; and the terminal equipment also supports the number Ng of antenna groups to be at least one or any more of 2, 4, 8.

For example, for a terminal equipment with the coherent type being a partial coherence and with two antenna groups, the terminal equipment at least supports the number Ng of antenna groups to be equal to 2; and the terminal equipment also supports the number Ng of antenna groups to be at least one or any more of 4 and 8.

For example, for a terminal equipment with the coherent type being a partial coherence and with four antenna groups, the terminal equipment at least supports the number Ng of antenna groups to be equal to 4; and the terminal equipment also supports the number Ng of antenna groups to be 8.

For example, for a terminal equipment with the coherent type being a non-coherence, the terminal equipment at least supports the number Ng of antenna groups to be equal to 8. Table 1 illustrates one example, which, for example, may be added to Section 4.2.7 in TS38.306.

TABLE 1
supportedNgValues
For full coherent UE, the UE should report supporting of Ng = {1, 2, 4, 8}
For partial coherent UE with two antenna groups, the UE should report
supporting of Ng = {2, 4, 8}
For partial coherent UE with four antenna groups, the UE should report
supporting of Ng = {4, 8}
For non-coherent UE, the UE should report supporting of Ng = {8}.

Table 2 illustrates another example, which, for example, may be added to Section 4.2.7 in TS38.306.

TABLE 2
supportedNgValues
For full coherent UE, the UE should at least report supporting of Ng = {1}
and the UE could optionally report
supporting of any values from Ng = {2, 4, 8}.
For partial coherent UE with two antenna groups, the UE should at least
report supporting of Ng = {2}, and the
UE could optionally report supporting of any values from Ng = {4, 8}.
For partial coherent UE with four antenna groups, the UE should at least
report supporting of Ng = {4}, and the
UE could optionally report supporting of Ng = {8}.
For non-coherent UE, the UE should report supporting of Ng = {8}.

The situation where the terminal equipment in the embodiments of this disclosure performs reporting according to the coherent type is schematically illustrated above, however, this disclosure is not limited thereto. The situation of the full power mode is schematically illustrated below. The full power mode 1 in the embodiments of this disclosure may be referred to as a mode 1, for example, other name may also be used. Please refer to ul-FullPwrMode1 in the related art for the specific content, however, this disclosure is not limited thereto. And modes with same or similar functions as ul-FullPwrMode1 in Rel-16 fall within the scope of this disclosure.

In some embodiments, for a terminal equipment with the coherent type being a non-coherence and supporting the full power mode 1, the number of supported antenna groups reported by the terminal equipment to the network device is 1 and 8.

For example, for a non-coherent UE that supports the full power mode 1, in addition to supporting of Ng={8}, the UE may additionally report supporting of Ng={1}, i.e., full coherent precoders are supported for full power transmission.

In some embodiments, for a terminal equipment with the coherent type being a non-coherence and supporting the full power mode 1, the network device configures non-coherent precoders and/or full coherent precoders for the terminal equipment according to the number of antenna groups reported by the terminal equipment.

For example, the gNB may configure non-coherent precoders (corresponding to Ng={8}) or full coherent precoders (corresponding to Ng={1}) for the UE.

For another example, the gNB may configure non-coherent precoders (corresponding to Ng={8}) and full coherent precoders (corresponding to Ng={1}) for the UE.

Table 3 illustrates another example, which, for example, may be added to Section 4.2.7 in TS38.306.

TABLE 3

supportedNgValues
For non-coherent UE, if the UE supports full power Mode 1,
the UE could report supporting of Ng = {1, 8}. The gNB
could configure non-coherent precoders and/or full
coherent precoders to the UE.

For another example, for a non-coherent UE that supports the full-power mode 1, in addition to supporting of Ng={8}, the UE may additionally report supporting of Ng={1}. The UE may also report supporting of Ng={2} and/or Ng={4}, i.e., partial coherent precoders at full power are supported. The gNB may configure respective precoders according to the capability reported by the UE.

In some embodiments, for a terminal equipment with the coherent type being a non-coherence and supporting the full power mode 1, the network device configures non-coherent precoders and/or full coherent precoders for the terminal equipment according to the number of antenna groups and/or other information (such as capability information) reported by the terminal equipment.

For example, for a non-coherent UE, i.e., the UE supports Ng={8}, if the UE supports the full power mode 1, the gNB may configure precoders to support full power according to capability information to support the full power mode 1 reported by the UE. The gNB may configure non-coherent precoders and/or full coherent precoders (for full power transmission) for the UE.

For another example, the UE reports supporting of Ng={8}, in addition, the UE also reports supporting of the full power mode 1. The gNB may configure non-coherent precoders (corresponding to Ng={8}) and/or full coherent precoders (corresponding to Ng={1}).

Table 4 illustrates another example, which, for example, may be added to Section 4.2.7 in TS38.306.

TABLE 4
supportedNgValues
For non-coherent UE, the UE should report supporting of Ng = {8}.
If the UE also indicating supporting of full power Mode 1,
then the gNB could configure non-coherent precoders and/or full
coherent precoders to the UE.

For another example, for a non-coherent UE, that is, the UE supports Ng={8}, if the UE supports the full power mode 1, the gNB may configure non-coherent precoders, and/or full coherent precoders, and/or partial coherent precoders for the UE.

In some embodiments, the network device may transmit downlink control information (DCI) to the terminal equipment. The non-coherent precoders and/or the full coherent precoders are indicated by one or more fields in the downlink control information (DCI).

For example, the field is a transmission precoding matrix indication (TPMI) field. This disclosure is not limited thereto, for example, other existing fields may be reused, or one or more new DCI fields may be introduced to indicate full coherent precoders.

In some embodiments, the number of first transmission precoding matrix indication (TPMI) fields indicating the non-coherent precoders is the same as the number of second transmission precoding matrix indication (TPMI) fields indicating the full coherent precoders, and/or a length of a first transmission precoding matrix indication (TPMI) field indicating the non-coherent precoders is the same as a length of a second transmission precoding matrix indication (TPMI) field indicating the full coherent precoders.

For example, the number N1 of first TPMIs indicating non-coherent precoders is the same as the number N2 of second TPMIs indicating full coherent precoders, i.e., N1=N2; and a length L1 of a first TPMI indicating non-coherent precoders is the same as a length L2 of a second TPMI indicating full coherent precoders, i.e., L1=L2.

For another example, the number N1 of the first TPMIs indicating non-coherent precoders is different from the number N2 of the second TPMIs indicating full coherent precoders, that is, N1 is not equal to N2; and the length L1 of the first TPMI indicating non-coherent precoders is the same as the length L2 of the second TPMI indicating full coherent precoders, that is, L1=L2.

For another example, the number N1 of the first TPMIs indicating non-coherent precoders is the same as the number N2 of the second TPMIs indicating full coherent precoders, that is, N1=N2; and the length L1 of the first TPMI indicating non-coherent precoders is different from the length L2 of the second TPMI indicating full coherent precoders, that is, L1 is not equal to L2.

For another example, the number N1 of the first TPMIs indicating non-coherent precoders is different from the number N2 of the second TPMIs indicating full coherent precoders, that is, N1 is not equal to N2; and the length L1 of the first TPMI indicating non-coherent precoders is different from the length L2 of the second TPMI indicating full coherent precoders, that is, L1 is not equal to L2.

In some embodiments, one or more code points of the transmission precoding matrix indication (TPMI) field are used to indicate the full coherent precoders.

For example, a bit width of the TPMI field is 4, and may include 16 code points from 0000 to 1111, of which two, for example, may be used to indicate the full coherent precoders.

The case where the non-coherent terminal equipment supports the full power mode 1 is described above. The case where the partial coherent terminal equipment with four antenna groups supports the full power mode 1 will be described below.

In some embodiments, for a terminal equipment with the coherent type being a partial coherence and with four antenna groups, if the terminal equipment supports the full power mode 1, the terminal equipment reports to the network device that the number of supported antenna groups is 4 and 1, or reports that the number of supported antenna groups is 4 and 8, or reports that the number of supported antenna groups is 4, 1 and 8.

For example, for a partial coherent UE with 4 antenna groups, if the full power mode 1 is supported, in addition to supporting of Ng={4}, the UE may also report supporting of Ng={1}, that is, full coherent precoders are supported for full power transmission. The UE may also report supporting of Ng={8}, that is, non-coherent precoders.

In some embodiments, for a terminal equipment with the coherent type being a partial coherence and with four antenna groups, if the terminal equipment supports the full power mode 1, the network device configures non-coherent precoders, or partial coherent precoders, or full coherent precoders, or partial coherent precoders and full coherent precoders for the terminal equipment.

For example, the gNB may configure partial coherent precoders with Ng={4}, or full coherent precoders (corresponding to Ng={1}), or non-coherent precoders (corresponding to Ng={8}). For another example, the gNB may configure partial coherent precoders with Ng={4} and full coherent precoders (corresponding to Ng={1}).

Table 5 illustrates another example, which, for example, may be added to Section 4.2.7 in TS38.306.

TABLE 5

supportedNgValues
For partial coherent UE with four antenna groups, if the UE
supports full power Mode 1, the UE could report supporting
of Ng = {1, 4}. The gNB could configure partial coherent
precoders with Ng = 4 and/or full coherent precoders to the UE.

Table 6 illustrates another example, which, for example, may be added to Section 4.2.7 in TS38.306.

TABLE 6
supportedNgValues
For partial coherent UE with four antenna groups, if the UE
supports full power Mode 1, the UE could report supporting of
Ng = {1, 4, 8}. The gNB could configure partial coherent precoders
with Ng = 4 and/or full coherent precoders to the UE. The gNB
could also configure non-coherent precoders to the UE.

For another example, for a partial coherent UE supporting the full power mode 1 and with 4 antenna groups, in addition to supporting of Ng={4}, the UE may additionally report supporting of Ng={1} and/or Ng={2}, i.e., full coherent precoders at full power are supported and partial coherent precoders at full power are supported. The gNB may configure the respective precoders according to the capability reported by the UE.

In some embodiments, for a partial coherent UE with 4 antenna groups, if the UE supports the full power mode 1, the gNB may configure precoders to support full power according to the capability to support the full power mode 1 reported by the UE. The gNB may configure partial coherent precoders with Ng=4 and/or full coherent precoders (for full power transmission) for the UE.

For example, the UE reports supporting of Ng={4}, in addition, the UE also reports supporting of the full power mode 1. The gNB may configure partial coherent precoders with Ng={4}, and/or full coherent precoders.

For another example, for a partial coherent UE with 4 antenna groups, that is, the UE supports Ng={4}, if the UE supports the full power mode 1, the gNB may configure non-coherent precoders and/or full coherent precoders and/or partial coherent precoders with Ng={4} for the UE.

Table 7 illustrates another example, which, for example, may be added to Section 4.2.7 in TS38.306.

TABLE 7

supportedNgValues
For partial coherent UE with four antenna groups, the UE
should report supporting of Ng = {4}. If the UE also indicating
supporting of full power Mode 1, then the gNB could configure
partial coherent precoders with Ng = 4 and/or full coherent
precoders to the UE.

Table 8 illustrates another example, which, for example, may be added to Section 4.2.7 in TS38.306.

TABLE 8

supportedNgValues
For partial coherent UE with four antenna groups, the UE
should report supporting of Ng = {4, 8}. If the UE also
indicating supporting of full power Mode 1, then the gNB could
configure partial coherent precoders with Ng = 4 and/or full
coherent precoders to the UE. The gNB could also configure non-
coherent precoders to the UE.

In some embodiments, the network device may transmit downlink control information (DCI) to the terminal equipment. The partial coherent precoders and/or the full coherent precoders are indicated by one or more fields in the downlink control information (DCI).

For example, the field is a transmission precoding matrix indication (TPMI) field. This disclosure is not limited thereto, for example, other existing fields may be reused, or one or more new DCI fields may be introduced to indicate full coherent precoders.

In some embodiments, the number of third transmission precoding matrix indication (TPMI) fields indicating the partial coherent precoders is the same as the number of second transmission precoding matrix indication (TPMI) fields indicating the full coherent precoders, and/or a length of a third transmission precoding matrix indication (TPMI) field indicating the partial coherent precoders is the same as a length of a second transmission precoding matrix indication (TPMI) field indicating the full coherent precoders.

For example, for a partial coherent UE with 4 antenna groups, if the UE supports the full power mode 1, the gNB may configure partial coherent precoders with Ng={4} or full coherent precoders. In the DCI, for the partial coherent precoders with Ng={4} or the full coherent precoders, the number of TPMI fields and the length of the TPMI field may be the same or different.

In some embodiments, one or more code points in the transmission precoding matrix indication (TPMI) field are used to indicate the full coherent precoding.

For example, the gNB may configure partial coherent precoders with Ng={4} and full coherent precoders. In the TPMI field, one or more code points of the TPMI field may be used to indicate the full coherent precoders.

The case where the partial coherent terminal equipment with four antenna groups supports the full power mode 1 is described above. The case where the partial coherent terminal equipment with two antenna groups supports the full power mode 1 will be described below.

In some embodiments, for a terminal equipment with the coherent type being a partial coherence and with two antenna groups, if the terminal equipment supports the full power mode 1, the terminal equipment reports to the network device that the number of supported antenna groups is 2, and also reports that the number of supported antenna groups is at least one or any more of 1, 4 and 8.

For example, for a partial coherent UE with 2 antenna groups, if the full power mode 1 is supported, in addition to supporting of Ng={2}, the UE may also additionally report supporting of Ng={1}, i.e., full coherent precoders are supported for full power transmission. The UE may also report supporting of Ng={4, 8}, i.e., partial coherent precoders with Ng={4} and non-coherent precoders.

For another example, the gNB may configure partial coherent precoders with Ng={2}, or full coherent precoders (corresponding to Ng={1}), or partial coherent precoders with Ng={4}, or non-coherent precoders (corresponding to Ng={8}).

For another example, the gNB may configure partial coherent precoders with Ng={2} and full coherent precoders (corresponding to Ng={1}).

Table 9 illustrates another example, which, for example, may be added to Section 4.2.7 in TS38.306.

TABLE 9

supportedNgValues
For partial coherent UE with two antenna groups, if the UE
supports full power Mode 1, the UE could report supporting
of Ng = {1, 2}. The gNB could configure partial coherent
precoders with Ng = 2, and/or full coherent precoders to the UE.

Table 10 illustrates another example, which, for example, may be added to Section 4.2.7 in TS38.306.

TABLE 10

supportedNgValues
For partial coherent UE with two antenna groups, if the UE
supports full power Mode 1, the UE could report supporting
of Ng = {1, 2, 4, 8}. The gNB could configure partial
coherent precoders with Ng = 2, and/or full coherent precoders
to the UE. The gNB could also configure partial coherent
precoders with Ng = 4 or non-coherent precoders to the UE.

In some embodiments, for a terminal equipment with the coherent type being a partial coherence and with two antenna groups, if the terminal equipment supports the full power mode 1, the network device configures non-coherent precoders, or partial coherent precoders, or full coherent precoders, or partial coherent precoders and full coherent precoders for the terminal equipment.

For example, for a partial coherent UE with 2 antenna groups, if the UE supports the full power mode 1, the gNB may configure precoders to support full power according to the capability to support the full power mode 1 reported by the UE. The gNB may configure partial coherent precoders with Ng={2} and/or full coherent precoders (for full power transmission) for the UE.

For example, the UE reports supporting of Ng={2}, in addition, the UE reports supporting of the full power mode 1. The gNB may configure partial coherent precoders with Ng={2}, and/or full coherent precoders.

For another example, for a partial coherent UE with 2 antenna groups, that is, the UE supports Ng={2}, if the UE supports the full power mode 1, the gNB may configure non-coherent precoders and/or full coherent precoders and/or partial coherent precoders with Ng={2} and/or partial coherent precoders with Ng={4} for the UE.

Table 11 illustrates another example, which, for example, may be added to Section 4.2.7 in TS38.306.

TABLE 11

supportedNgValues
For partial coherent UE with two antenna groups, the UE
should report supporting of Ng = {2}. If the UE also indicating
supporting of full power Mode 1, then the gNB could configure
partial coherent precoders with Ng = 2 and/or full coherent
precoders to the UE.

Table 12 illustrates another example, which, for example, may be added to Section 4.2.7 in TS38.306.

TABLE 12

supportedNgValues
For partial coherent UE with two antenna groups, the UE should
report supporting of Ng = {2, 4, 8}. If the UE also indicating
supporting of full power Mode 1, then the gNB could configure
partial coherent precoders with Ng = 2 and/or full coherent
precoders to the UE. The gNB could also configure partial coherent
precoders with Ng = 4 or non-coherent precoders to the UE.

In some embodiments, the network device may transmit downlink control information (DCI) to the terminal equipment. The partial coherent precoders and/or the full coherent precoders are indicated by one or more fields in the downlink control information (DCI).

For example, the field is a transmission precoding matrix indication (TPMI) field. This disclosure is not limited thereto, for example, other existing fields may be reused, or one or more new DCI fields may be introduced to indicate full coherent precoders.

In some embodiments, the number of third transmission precoding matrix indication (TPMI) fields indicating the partial coherent precoders is the same as the number of second transmission precoding matrix indication (TPMI) fields indicating the full coherent precoders, and/or a length of a third transmission precoding matrix indication (TPMI) field indicating the partial coherent precoders is the same as a length of a second transmission precoding matrix indication (TPMI) field indicating the full coherent precoders.

For example, for a partial coherent UE with 2 antenna groups, if the UE supports the full power mode 1, the gNB may configure partial coherent precoders with Ng={2} or full coherent precoders. In the DCI, for the partial coherent precoders with Ng={2} or full coherent precoders, the number of TPMI fields and the length of the TPMI field may be the same or different.

In some embodiments, one or more code points in the transmission precoding matrix indication (TPMI) field are used to indicate the full coherent precoders.

For example, the gNB may configure partial coherent precoders with Ng={2} and full coherent precoders. In the TPMI field, one or more code points of the TPMI field may be used to indicate the full coherent precoders.

The above embodiments only illustrate the disclosure. However, this disclosure is not limited thereto, and appropriate variants may be made on the basis of the above embodiments. For example, the above embodiments may be used alone, or one or more of the above embodiments may be combined together.

As can be seen from the above embodiments, for terminal equipments with different coherent types and/or whether the full power mode 1 is supported, the number of antenna groups reported by the terminal equipments and precoders configured by the network device can be clearly specified.

### Embodiments of a Second Aspect

The embodiments of this disclosure provide a precoding configuration method described from a network device side. The embodiments of the second aspect may be combined with the embodiments of the first aspect. Same contents as those of the embodiments of the first aspect will not be described again.

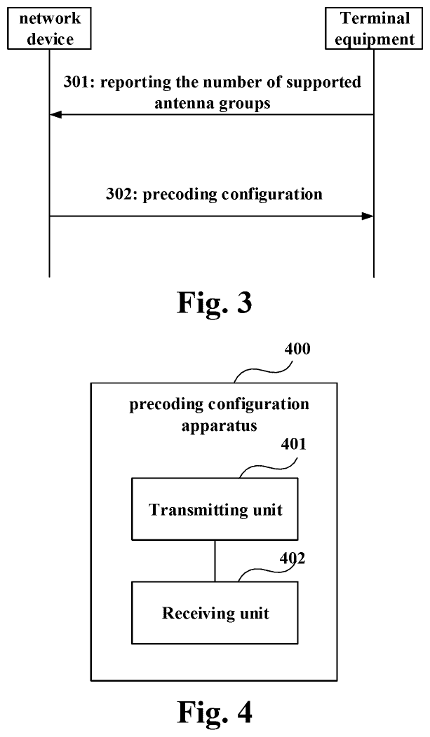

FIG. 3 is a schematic diagram illustrating a precoding configuration method according to an embodiment of this disclosure. As illustrated in the FIG. 3, the method includes:
301: a network device receives the number of antenna groups supported by a terminal equipment and reported by the terminal equipment, wherein the terminal equipment reports the number of antenna groups according to a coherent type and/or whether a full power mode 1 is supported; and
302: the network device transmits precoding configuration information to the terminal equipment according to the number of antenna groups supported by the terminal equipment and/or whether the terminal equipment supports the full power mode 1.

It should be noted that the FIG. 3 only schematically illustrates the embodiments of this disclosure, however, this disclosure is not limited thereto. For example, an order of execution of the operations may be appropriately adjusted, and furthermore, some other operations may be added, or some operations therein may be removed. And appropriate variants may be made by those skilled in the art according to the above content, without being limited to the disclosure illustrated in the FIG. 3.

In some embodiments, for a terminal equipment with the coherent type being a full coherence, the terminal equipment at least supports the number Ng of antenna groups to be equal to 1. The terminal equipment also supports the number Ng of antenna groups to be at least one or any more of 2, 4, 8.

In some embodiments, for a terminal equipment with the coherent type being a partial coherence and with two antenna groups, the terminal equipment at least supports the number Ng of antenna groups to be equal to 2. The terminal equipment also supports the number Ng of antenna groups to be at least one or any more of 4 and 8.

In some embodiments, for a terminal equipment with the coherent type being a partial coherence and with four antenna groups, the terminal equipment at least supports the number Ng of antenna groups to be equal to 4. The terminal equipment also supports the number Ng of antenna groups to be 8.

In some embodiments, for a terminal equipment with the coherent type being a non-coherence, the terminal equipment at least supports the number Ng of antenna groups to be equal to 8.

In some embodiments, for a terminal equipment with the coherent type being a non-coherence and supporting the full power mode 1, the terminal equipment reports to the network device that the number of supported antenna groups is 1 and 8.

In some embodiments, for a terminal equipment with the coherent type being a non-coherence and supporting the full power mode 1, the network device configures non-coherent precoders and/or full coherent precoders for the terminal equipment.

In some embodiments, the non-coherent precoders and/or the full coherent precoders are indicated by one or more fields in downlink control information (DCI).

In some embodiments, the field is a transmission precoding matrix indication (TPMI) field.

In some embodiments, the number of first transmission precoding matrix indication (TPMI) fields indicating the non-coherent precoders is the same as the number of second transmission precoding matrix indication (TPMI) fields indicating the full coherent precoders, and/or a length of a first transmission precoding matrix indication (TPMI) field indicating the non-coherent precoders is the same as a length of a second transmission precoding matrix indication (TPMI) field indicating the full coherent precoders.

In some embodiments, one or more code points in the transmission precoding matrix indication (TPMI) field are used to indicate the full coherent precoders.

In some embodiments, for a terminal equipment with the coherent type being a partial coherence and with four antenna groups, if the terminal equipment supports the full power mode 1, the terminal equipment reports to the network device that the number of supported antenna groups is 4 and 1, or reports that the number of supported antenna groups is 4 and 8, or reports that the number of supported antenna groups is 4, 1 and 8.

In some embodiments, for a terminal equipment with the coherent type being a partial coherence and with four antenna groups, if the terminal equipment supports the full power mode 1, the network device configures non-coherent precoders, or partial coherent precoders, or full coherent precoders, or partial coherent precoders and full coherent precoders for the terminal equipment.

In some embodiments, the partial coherent precoders and/or the full coherent precoders are indicated by one or more fields in downlink control information (DCI).

In some embodiments, the field is a transmission precoding matrix indication (TPMI) field.

In some embodiments, the number of third transmission precoding matrix indication (TPMI) fields indicating the partial coherent precoders is the same as the number of second transmission precoding matrix indication (TPMI) fields indicating the full coherent precoders, and/or a length of a third transmission precoding matrix indication (TPMI) field indicating the partial coherent precoders is the same as a length of a second transmission precoding matrix indication (TPMI) field indicating the full coherent precoders.

In some embodiments, one or more code points in the transmission precoding matrix indication (TPMI) field are used to indicate the full coherent precoders.

In some embodiments, for a terminal equipment with the coherent type being a partial coherence and with two antenna groups, if the terminal equipment supports the full power mode 1, the terminal equipment reports to the network device that the number of supported antenna groups is 2, and also reports that the number of supported antenna groups is at least one or any more of 1, 4, 8.

In some embodiments, for a terminal equipment with the coherent type being a partial coherence and with two antenna groups, if the terminal equipment supports the full power mode 1, the network device configures non-coherent precoders, or partial coherent precoders, or full coherent precoders, or partial coherent precoders and full coherent precoders for the terminal equipment.

In some embodiments, the partial coherent precoders and/or the full coherent precoders are indicated by one or more fields in downlink control information (DCI).

In some embodiments, the field is a transmission precoding matrix indication (TPMI) field.

In some embodiments, the number of third transmission precoding matrix indication (TPMI) fields indicating the partial coherent precoders is the same as the number of second transmission precoding matrix indication (TPMI) fields indicating the full coherent precoders, and/or a length of a third transmission precoding matrix indication (TPMI) field indicating the partial coherent precoders is the same as a length of a second transmission precoding matrix indication (TPMI) field indicating the full coherent precoders.

In some embodiments, one or more code points in the transmission precoding matrix indication (TPMI) field are used to indicate the full coherent precoders.

The above embodiments only illustrate the disclosure. However, this disclosure is not limited thereto, and appropriate variants may be made on the basis of the above embodiments. For example, the above embodiments may be used alone, or one or more of the above embodiments may be combined together.

As can be seen from the above embodiments, for terminal equipments with different coherent types and/or whether the full power mode 1 is supported, the number of antenna groups reported by the terminal equipment and the precoders configured by the network device can be clearly specified.

### Embodiments of a Third Aspect

The embodiments of this disclosure provide a precoding configuration apparatus. The apparatus may be, for example, a terminal equipment, or may be one or more components or assemblies configured in the terminal equipment. Same contents as those of the embodiments of the first aspect will not be described again.

FIG. 4 is a schematic diagram illustrating a precoding configuration apparatus according to an embodiment of this disclosure. As illustrated in the FIG. 4, a precoding configuration apparatus 400 includes:
a transmitting unit 401 configured to report the number of supported antenna groups to a network device according to a coherent type and/or whether a full power mode 1 is supported; and
a receiving unit 402 configured to receive precoding configuration information from the network device.

In some embodiments, for a terminal equipment with the coherent type being a full coherence, the terminal equipment at least supports the number Ng of antenna groups to be equal to 1; and the terminal equipment also supports the number Ng of antenna groups to be at least one or any more of 2, 4, 8.

In some embodiments, for a terminal equipment with the coherent type being a partial coherence and with two antenna groups, the terminal equipment at least supports the number Ng of antenna groups to be equal to 2; and the terminal equipment also supports the number Ng of antenna groups to be at least one or any more of 4 and 8.

In some embodiments, for a terminal equipment with the coherent type being a partial coherence and with four antenna groups, the terminal equipment at least supports the number Ng of antenna groups to be equal to 4; and the terminal equipment also supports the number Ng of antenna groups to be equal to 8.

In some embodiments, for a terminal equipment with the coherent type being a non-coherence, the terminal equipment at least supports the number Ng of antenna groups to be equal to 8.

In some embodiments, for a terminal equipment with the coherent type being a non-coherence and supporting the full power mode 1, the terminal equipment reports to the network device that the number of supported antenna groups is 1 and 8; and
the network device configures non-coherent precoders and/or full coherent precoders for the terminal equipment.

In some embodiments, the non-coherent precoders and/or the full coherent precoders are indicated by one or more fields in downlink control information (DCI); and
the field is a transmission precoding matrix indication (TPMI) field.

In some embodiments, the number of first transmission precoding matrix indication (TPMI) fields indicating the non-coherent precoders is the same as the number of second transmission precoding matrix indication (TPMI) fields indicating the full coherent precoders, and/or a length of a first transmission precoding matrix indication (TPMI) field indicating the non-coherent precoders is the same as a length of a second transmission precoding matrix indication (TPMI) field indicating the full coherent precoders.

In some embodiments, one or more code points in the transmission precoding matrix indication (TPMI) field are used to indicate the full coherent precoders.

In some embodiments, for a terminal equipment with the coherent type being a partial coherence and with four antenna groups, if the terminal equipment supports the full power mode 1, the terminal equipment reports to the network device that the number of supported antenna groups is 4 and 1, or reports that the number of supported antenna groups is 4 and 8, or reports that the number of supported antenna groups is 4, 1 and 8; and
the network device configures non-coherent precoders, or partial coherent precoders, or full coherent precoders, or partial coherent precoders and full coherent precoders for the terminal equipment.

In some embodiments, the partial coherent precoders and/or the full coherent precoders are indicated by one or more fields in downlink control information (DCI); and
the field is a transmission precoding matrix indication (TPMI) field.

In some embodiments, the number of third transmission precoding matrix indication (TPMI) fields indicating the partial coherent precoders is the same as the number of second transmission precoding matrix indication (TPMI) fields indicating the full coherent precoders, and/or a length of a third transmission precoding matrix indication (TPMI) field indicating the partial coherent precoders is the same as a length of a second transmission precoding matrix indication (TPMI) field indicating the full coherent precoders.

In some embodiments, one or more code points in the transmission precoding matrix indication (TPMI) field are used to indicate the full coherent precoders.

In some embodiments, for a terminal equipment with the coherent type being a partial coherence and with two antenna groups, if the terminal equipment supports the full power mode 1, the terminal equipment reports to the network device that the number of supported antenna groups is 2, and also reports that the number of supported antenna groups is at least one or any more of 1, 4, 8.

The network device configures non-coherent precoders, or partial coherent precoders, or full coherent precoders, or partial coherent precoders and full coherent precoders for the terminal equipment.

In some embodiments, the partial coherent precoders and/or the full coherent precoders are indicated by one or more fields in downlink control information (DCI); and
the field is a transmission precoding matrix indication (TPMI) field.

In some embodiments, the number of third transmission precoding matrix indication (TPMI) fields indicating the partial coherent precoders is the same as the number of second transmission precoding matrix indication (TPMI) fields indicating the full coherent precoders, and/or a length of a third transmission precoding matrix indication (TPMI) field indicating the partial coherent precoders is the same as a length of a second transmission precoding matrix indication (TPMI) field indicating the full coherent precoders.

In some embodiments, one or more code points in the transmission precoding matrix indication (TPMI) field are used to indicate the full coherent precoders.

It should be noted that the components or modules related to this disclosure are only described above, however, this disclosure is not limited thereto. The precoding configuration apparatus 400 may also include other components or modules. Refer to the related arts for the specific content of these components or modules.

In addition, for the sake of simplicity, the FIG. 4 only illustrates a connection relationship or a signaling direction between components or modules, however, those skilled in the art should appreciate that the related arts such as bus connections can be adopted. The components or modules can be implemented by hardware facilities, such as a processor, a memory, a transmitter, and a receiver, which is not limited in this disclosure.

In view of the embodiments of this disclosure, for terminal equipments with different coherent types and/or whether the full power mode 1 is supported, the number of antenna groups reported by the terminal equipment and the precoders configured by the network device can be clearly specified.

### Embodiments of a Fourth Aspect

The embodiments of this disclosure provide a precoding configuration apparatus. The apparatus may be, for example, a network device, or may be one or more components or assemblies configured in the network device. Same contents as those of the embodiments of the first and second aspects will not be described again.

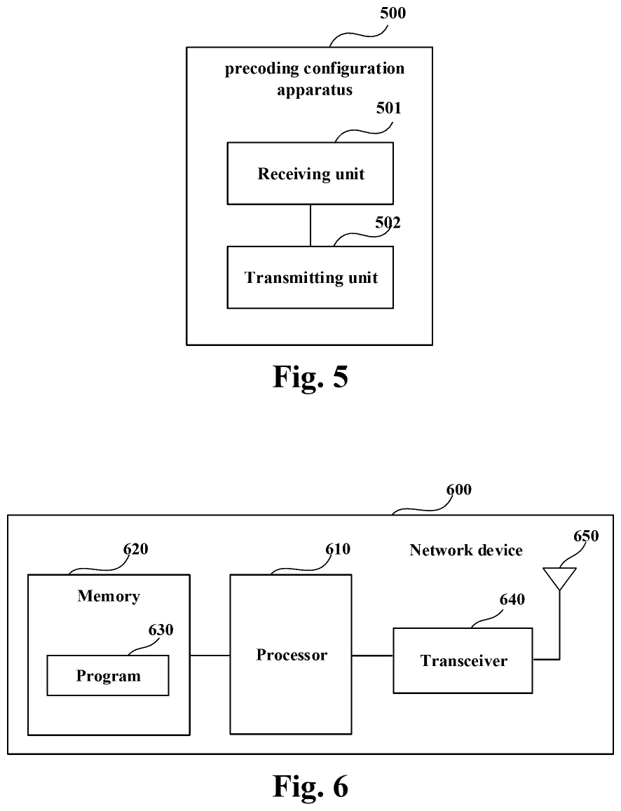

FIG. 5 is a schematic diagram illustrating a precoding configuration apparatus according to an embodiment of this disclosure. As illustrated in the FIG. 5, a precoding configuration apparatus 500 includes:
a receiving unit 501 configured to receive the number of antenna groups supported by a terminal equipment and reported by the terminal equipment, wherein the terminal equipment reports the number of antenna groups according to a coherent type and/or whether a full power mode 1 is supported; and
a transmitting unit 502 configured to transmit precoding configuration information to the terminal equipment according to the number of antenna groups supported by the terminal equipment and/or whether the terminal equipment supports the full power mode 1.

In some embodiments, for a terminal equipment with the coherent type being a full coherence, the terminal equipment at least supports the number Ng of antenna groups to be equal to 1, and the terminal equipment also supports the number Ng of antenna groups to be at least one or any more of 2, 4 and 8.

For a terminal equipment with the coherent type being a partial coherence and with two antenna groups, the terminal equipment at least supports the number Ng of antenna groups to be equal to 2, and the terminal equipment also supports the number Ng of antenna groups to be at least one or any more of 4 and 8.

For a terminal equipment with the coherent type being a partial coherence and with four antenna groups, the terminal equipment at least supports the number Ng of antenna groups to be equal to 4, and the terminal equipment also supports the number Ng of antenna groups to be 8.

For a terminal equipment with the coherent type being a non-coherence, the terminal equipment at least supports the number Ng of antenna groups to be equal to 8.

It should be noted that the components or modules related to this disclosure are only described above, however, this disclosure is not limited thereto. The precoding configuration apparatus 500 may also include other components or modules. Refer to the related arts for the specific content of these components or modules.

In addition, for the sake of simplicity, the FIG. 5 only exemplifies a connection relationship or a signaling direction between components or modules, however, those skilled in the art should appreciate that the related arts such as bus connections can be adopted. The components or modules can be implemented by hardware facilities, such as a processor, a memory, a transmitter, and a receiver, which is not limited in this disclosure.

In view of the embodiments of this disclosure, for terminal equipments with different coherent types and/or whether the full power mode 1 is supported, the number of antenna groups reported by the terminal equipment and the precoders configured by the network device can be clearly specified.

### Embodiments of a Fifth Aspect

The embodiments of this disclosure also provide a communication system. Reference can be made to the FIG. 1. Same contents as those of the embodiments of the first to fourth aspects will not be described again.

In some embodiments, a communication system 100 may at least include:
a terminal equipment, capable of supporting an 8-transmission (8Tx) uplink transmission, configured to report the number of supported antenna groups to a network device according to a coherent type and/or whether a full power mode 1 is supported; and
a network device configured to transmit precoding configuration information to the terminal equipment according to the number of antenna groups supported by the terminal equipment and/or whether the terminal equipment supports the full power mode 1.

The embodiments of this disclosure further provide a network device, which may be, for example, a base station, however, this disclosure is not limited thereto, and other network devices may also be involved.

FIG. 6 is a schematic diagram illustrating a composition of a network device according to an embodiment of this disclosure. As illustrated in the FIG. 6, a network device 600 may include: a processor 610 (e.g., a central processing unit (CPU)) and a memory 620 coupled to the processor 610. The memory 620 may store various data. In addition, the memory 620 may store a program 630 for information processing, and the program 630 may be executed under the control of the processor 610.

For example, the processor 610 may be configured to execute a program to implement the precoding configuration method according to the embodiments of the second aspect. For example, the processor 610 may be configured to receive the number of antenna groups supported by a terminal equipment and reported by the terminal equipment, wherein the terminal equipment reports the number of antenna groups according to a coherent type and/or whether a full power mode 1 is supported; and transmit precoding configuration information to the terminal equipment according to the number of antenna groups supported by the terminal equipment and/or whether the terminal equipment supports the full power mode 1.

In addition, as illustrated in the FIG. 6, the network device 600 may further include: a transceiver 640 and an antenna 650, wherein the functions of the above components are similar to those in the relevant art and will not be described again herein. It should be noted that the network device 600 does not necessarily include all the components illustrated in the FIG. 6. In addition, the network device 600 may also include components not illustrated in the FIG. 6. Please refer to the relevant art.

The embodiments of this disclosure also provide a terminal equipment, however, this disclosure is not limited thereto, and other devices may also be involved.

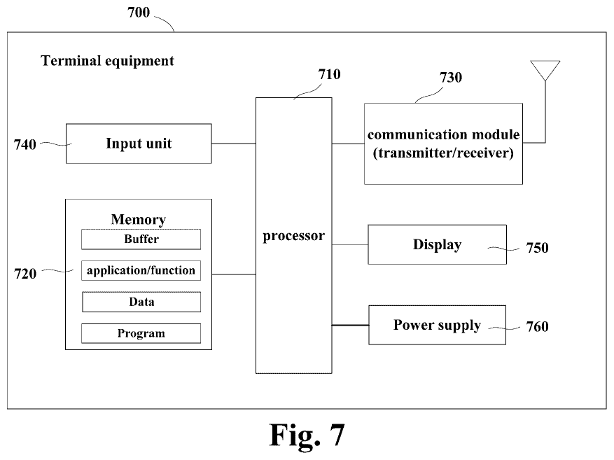

FIG. 7 is a schematic diagram illustrating a terminal equipment according to an embodiment of this disclosure. As illustrated in the FIG. 7, a terminal equipment 700 may include a processor 710 and a memory 720 that stores data and a program and is coupled to the processor 710. It should be noted that the figure is exemplary; and other types of structures may also be used to supplement or replace this structure, in order to implement telecommunication functions or other functions.

For example, the processor 710 may be configured to execute a program to implement the precoding configuration method according to the embodiments of the first aspect. For example, the processor 710 may be configured to report the number of supported antenna groups to a network device according to a coherent type and/or whether a full power mode 1 is supported; and receive precoding configuration information from the network device.

As illustrated in the FIG. 7, the terminal equipment 700 may further include: a communication module 730, an input unit 740, a display 750, and a power supply 760, wherein the functions of the above components are similar to those in the relevant art and will not be described again herein. It should be noted that the terminal equipment 700 does not necessarily include all the components illustrated in the FIG. 7, and the above components are not necessarily required. In addition, the terminal equipment 700 may also include components not illustrated in the FIG. 7. Please refer to the relevant art.

The embodiments of this disclosure also provide a computer program, wherein when the program is executed in a terminal equipment, the program enables the terminal equipment to perform the precoding configuration method according to the embodiments of the first aspect.

The embodiments of this disclosure also provide a storage medium storing a computer program, wherein the computer program enables a terminal equipment to perform the precoding configuration method according to the embodiments of the first aspect.

The embodiments of this disclosure also provide a computer program, wherein when the program is executed in a network device, the program enables the network device to perform the precoding configuration method according to the embodiments of the second aspect.

The embodiments of this disclosure also provide a storage medium storing a computer program, wherein the computer program enables a network device to perform the precoding configuration method according to the embodiments of the second aspect.

The above device and method of this disclosure may be implemented by hardware, or by hardware in combination with software. This disclosure relates to such a computer-readable program that when the program is executed by a logic device, the logic device is enabled to carry out the device or components as described above, or to carry out the method or steps as described above. This disclosure also relates to a storage medium for storing the above program, such as a hard disk, a magnetic disk, a CD, a DVD, and a flash memory, etc.

The method/device described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. These software modules may respectively correspond to the steps shown in the drawings. And these hardware modules, for example, may be carried out by firming these software modules by using a field programmable gate array (FPGA).

The software modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information to the memory medium; or the memory medium may be a component of the processor. The processor and the memory medium may be located in an ASIC. The software modules may be stored in a memory of a mobile terminal and may also be stored in a memory card of a pluggable mobile terminal. For example, if equipment (such as a mobile terminal) employs an MEGA-SIM card of a relatively large capacity or a flash memory device of a large capacity, the software modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this disclosure. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and amendments to this disclosure may be made by those skilled in the art according to principle of this disclosure, and such variants and amendments fall within the scope of this disclosure.

As to implementations containing the above embodiments, supplements are further disclosed below:

1. A precoding configuration method applied to a terminal equipment capable of supporting an 8-transmission (8Tx) uplink transmission, including:
reporting, by the terminal equipment, the number of supported antenna groups to a network device according to a coherent type and/or whether a full power mode 1 is supported; and
receiving, by the terminal equipment, precoding configuration information from the network device.

2. The method according to supplement 1, wherein for a terminal equipment with the coherent type being a full coherence, the terminal equipment at least supports the number Ng of antenna groups to be equal to 1.

3. The method according to supplement 2, wherein the terminal equipment also supports the number Ng of antenna groups to be at least one or any more of 2, 4, 8.

4. The method according to supplement 1, wherein for a terminal equipment with the coherent type being a partial coherence and with two antenna groups, the terminal equipment at least supports the number Ng of antenna groups to be equal to 2.

5. The method according to supplement 4, wherein the terminal equipment also supports the number Ng of antenna groups to be at least one or any more of 4 and 8.

6. The method according to supplement 1, wherein for a terminal equipment with the coherent type being a partial coherence and with four antenna groups, the terminal equipment at least supports the number Ng of antenna groups to be equal to 4.

7. The method according to supplement 6, wherein the terminal equipment also supports the number Ng of antenna groups to be 8.

8. The method according to supplement 1, wherein for a terminal equipment with the coherent type being a non-coherence, the terminal equipment at least supports the number Ng of antenna groups to be equal to 8.

9. The method according to supplement 1, wherein for a terminal equipment with the coherent type being a non-coherence and supporting the full power mode 1, the terminal equipment reports to the network device that the number of supported antenna groups is 1 and 8.

10. The method according to supplement 1 or 9, wherein for a terminal equipment with the coherent type being a non-coherence and supporting the full power mode 1, the network device configures non-coherent precoders and/or full coherent precoders for the terminal equipment.

11. The method according to supplement 10, wherein the non-coherent precoders and/or the full coherent precoders are indicated by one or more fields in downlink control information (DCI).

12. The method according to supplement 11, wherein the field is a transmission precoding matrix indication (TPMI) field.

13. The method according to supplement 12, wherein the number of first transmission precoding matrix indication (TPMI) fields indicating the non-coherent precoders is the same as the number of second transmission precoding matrix indication (TPMI) fields indicating the full coherent precoders, and/or a length of a first transmission precoding matrix indication (TPMI) field indicating the non-coherent precoders is the same as a length of a second transmission precoding matrix indication (TPMI) field indicating the full coherent precoders.

14. The method according to supplement 12, wherein one or more code points of the transmission precoding matrix indication (TPMI) field are used to indicate the full coherent precoders.

15. The method according to supplement 1, wherein for a terminal equipment with the coherent type being a partial coherence and with four antenna groups, if the terminal equipment supports the full power mode 1, the terminal equipment reports to the network device that the number of supported antenna groups is 4 and 1, or reports that the number of supported antenna groups is 4 and 8, or reports that the number of supported antenna groups is 4, 1 and 8.

16. The method according to supplement 1 or 15, wherein for a terminal equipment with the coherent type being a partial coherence and with four antenna groups, if the terminal equipment supports the full power mode 1, the network device configures non-coherent precoders, or partial coherent precoders, or full coherent precoders, or partial coherent precoders and full coherent precoders for the terminal equipment.

17. The method according to supplement 16, wherein the partial coherent precoders and/or the full coherent precoders are indicated by one or more fields in downlink control information (DCI).

18. The method according to supplement 17, wherein the field is a transmission precoding matrix indication (TPMI) field.

19. The method according to supplement 18, wherein the number of third transmission precoding matrix indication (TPMI) fields indicating the partial coherent precoders is the same as the number of second transmission precoding matrix indication (TPMI) fields indicating the full coherent precoders, and/or a length of a third transmission precoding matrix indication (TPMI) field indicating the partial coherent precoders is the same as a length of a second transmission precoding matrix indication (TPMI) field indicating the full coherent precoders.

20. The method according to supplement 18, wherein one or more code points of the transmission precoding matrix indication (TPMI) field are used to indicate the full coherent precoders.

21. The method according to supplement 1, wherein for a terminal equipment with the coherent type being a partial coherence and with two antenna groups, if the terminal equipment supports the full power mode 1, the terminal equipment reports to the network device that the number of supported antenna groups is 2, and also reports that the number of supported antenna groups is at least one or any more of 1, 4 and 8.

22. The method according to supplement 1 or 21, wherein for a terminal equipment with the coherent type being a partial coherence and with two antenna groups, if the terminal equipment supports the full power mode 1, the network device configures non-coherent precoders, or partial coherent precoders, or full coherent precoders, or partial coherent precoders and full coherent precoders for the terminal equipment.

23. The method according to supplement 22, wherein the partial coherent precoders and/or the full coherent precoders are indicated by one or more fields in downlink control information (DCI).

24. The method according to supplement 23, wherein the field is a transmission precoding matrix indication (TPMI) field.

25. The method according to supplement 24, wherein the number of third transmission precoding matrix indication (TPMI) fields indicating the partial coherent precoders is the same as the number of second transmission precoding matrix indication (TPMI) fields indicating the full coherent precoders, and/or a length of a third transmission precoding matrix indication (TPMI) field indicating the partial coherent precoders is the same as a length of a second transmission precoding matrix indication (TPMI) field indicating the full coherent precoders.

26. The method according to supplement 24, wherein one or more code points of the transmission precoding matrix indication (TPMI) field are used to indicate the full coherent precoders.

27. A precoding configuration method applied to a network device, including:
a network device configured to receive the number of antenna groups supported by a terminal equipment and reported by the terminal equipment, wherein the terminal equipment reports the number of antenna groups according to a coherent type and/or whether a full power mode 1 is supported; and
a network device configured to transmit precoding configuration information to the terminal equipment according to the number of antenna groups supported by the terminal equipment and/or whether the terminal equipment supports the full power mode 1.

28. The method according to supplement 27, wherein for a terminal equipment with the coherent type being a full coherence, the terminal equipment at least supports the number Ng of antenna groups to be equal to 1.

29. The method according to supplement 28, wherein the terminal equipment also supports the number Ng of antenna groups to be at least one or any more of 2, 4, 8.

30. The method according to supplement 27, wherein for a terminal equipment with the coherent type being a partial coherence and with two antenna groups, the terminal equipment at least supports the number Ng of antenna groups to be equal to 2.

31. The method according to supplement 30, wherein the terminal equipment also supports the number Ng of antenna groups to be at least one or any more of 4 and 8.

32. The method according to supplement 27, wherein for a terminal equipment with the coherent type being a partial coherence and with four antenna groups, the terminal equipment at least supports the number Ng of antenna groups to be equal to 4.

33. The method according to supplement 32, wherein the terminal equipment also supports the number Ng of antenna groups to be 8.

34. The method according to supplement 27, wherein for a terminal equipment with the coherent type being a non-coherence, the terminal equipment at least supports the number Ng of antenna groups to be equal to 8.

35. The method according to supplement 27, wherein for a terminal equipment with the coherent type being a non-coherence and supporting the full power mode 1, the terminal equipment reports to the network device that the number of supported antenna groups is 1 and 8.

36. The method according to supplement 27 or 35, wherein for a terminal equipment with the coherent type being a non-coherence and supporting the full power mode 1, the network device configures non-coherent precoders and/or full coherent precoders for the terminal equipment.

37. The method according to supplement 36, wherein the non-coherent precoders and/or the full coherent precoders are indicated by one or more fields in downlink control information (DCI).

38. The method according to supplement 37, wherein the field is a transmission precoding matrix indication (TPMI) field.

39. The method according to supplement 38, wherein the number of first transmission precoding matrix indication (TPMI) fields indicating the non-coherent precoders is the same as the number of second transmission precoding matrix indication (TPMI) fields indicating the full coherent precoders, and/or a length of a first transmission precoding matrix indication (TPMI) field indicating the non-coherent precoders is the same as a length of a second transmission precoding matrix indication (TPMI) field indicating the full coherent precoders.

40. The method according to supplement 38, wherein one or more code points of the transmission precoding matrix indication (TPMI) field are used to indicate the full coherent precoders.

41. The method according to supplement 27, wherein for a terminal equipment with the coherent type being a partial coherence and with four antenna groups, if the terminal equipment supports the full power mode 1, the terminal equipment reports to the network device that the number of supported antenna groups is 4 and 1, or reports that the number of supported antenna groups is 4 and 8, or reports that the number of supported antenna groups is 4, 1 and 8.

42. The method according to supplement 27 or 41, wherein for a terminal equipment with the coherent type being a partial coherence and with four antenna groups, if the terminal equipment supports the full power mode 1, the network device configures non-coherent precoders, or partial coherent precoders, or full coherent precoders, or partial coherent precoders and full coherent precoders for the terminal equipment.

43. The method according to supplement 42, wherein the partial coherent precoders and/or the full coherent precoders are indicated by one or more fields in downlink control information (DCI).

44. The method according to supplement 43, wherein the field is a transmission precoding matrix indication (TPMI) field.

45. The method according to supplement 44, wherein the number of third transmission precoding matrix indication (TPMI) fields indicating the partial coherent precoders is the same as the number of second transmission precoding matrix indication (TPMI) fields indicating the full coherent precoders, and/or a length of a third transmission precoding matrix indication (TPMI) field indicating the partial coherent precoders is the same as a length of a second transmission precoding matrix indication (TPMI) field indicating the full coherent precoders.

46. The method according to supplement 44, wherein one or more code points of the transmission precoding matrix indication (TPMI) field are used to indicate the full coherent precoders.

47. The method according to supplement 27, wherein for a terminal equipment with the coherent type being a partial coherence and with two antenna groups, if the terminal equipment supports the full power mode 1, the terminal equipment reports to the network device that the number of supported antenna groups is 2, and also reports that the number of supported antenna groups is at least one or any more of 1, 4 and 8.

48. The method according to supplement 27 or 47, wherein for a terminal equipment with the coherent type being a partial coherence and with two antenna groups, if the terminal equipment supports the full power mode 1, the network device configures non-coherent precoders, or partial coherent precoders, or full coherent precoders, or partial coherent precoders and full coherent precoders for the terminal equipment.

49. The method according to supplement 48, wherein the partial coherent precoders and/or the full coherent precoders are indicated by one or more fields in downlink control information (DCI).

50. The method according to supplement 49, wherein the field is a transmission precoding matrix indication (TPMI) field.

51. The method according to supplement 50, wherein the number of third transmission precoding matrix indication (TPMI) fields indicating the partial coherent precoders is the same as the number of second transmission precoding matrix indication (TPMI) fields indicating the full coherent precoders, and/or a length of a third transmission precoding matrix indication (TPMI) field indicating the partial coherent precoders is the same as a length of a second transmission precoding matrix indication (TPMI) field indicating the full coherent precoders.

52. The method according to supplement 50, wherein one or more code points in the transmission precoding matrix indication (TPMI) field are used to indicate the full coherent precoders.

53. A terminal equipment, including: a memory and a processor, wherein the memory stores a computer program, and the processor is configured to execute the computer program to implement the precoding configuration method according to any one of supplements 1 to 26.

54. A network device, including: a memory and a processor, wherein the memory stores a computer program, and the processor is configured to execute the computer program to implement the precoding configuration method according to any one of supplements 27 to 52.

1. A precoding configuration apparatus, configured in a terminal equipment capable of supporting an 8Tx uplink transmission, the apparatus comprising:
a transmitter configured to report, to a network device, first information indicating the number of supported antenna groups and second information indicating whether a full power mode 1 is supported by the terminal equipment; and
a receiver configured to receive, from the network device, precoding configuration information for indicating a precoder type which is determined by the network device according to the first information and the second information, and
wherein the receiver is further configured to receive downlink control information including a transmission precoding matrix indication field indicating a value in one or more values which are indicated according to the precoding configuration information.

2. The apparatus according to claim 1, wherein for a terminal equipment with a precoder type being a full coherence, the terminal equipment at least supports the number Ng of antenna groups to be equal to 1; and the terminal equipment also supports the number Ng of antenna groups to be at least one or any more of 2, 4, 8.

3. The apparatus according to claim 1, wherein for a terminal equipment with a precoder type being a partial coherence and with two antenna groups, the terminal equipment at least supports the number Ng of antenna groups to be equal to 2; and the terminal equipment also supports the number Ng of antenna groups to be at least one or any more of 4 and 8.

4. The apparatus according to claim 1, wherein for a terminal equipment with a precoder type being a partial coherence and with four antenna groups, the terminal equipment at least supports the number Ng of antenna groups to be equal to 4; and the terminal equipment also supports the number Ng of antenna groups to be 8.

5. The apparatus according to claim 1, wherein for a terminal equipment with a precoder type being a non-coherence, the terminal equipment at least supports the number Ng of antenna groups to be equal to 8.

6. The apparatus according to claim 1, wherein for a terminal equipment with a precoder type being a non-coherence and supporting the full power mode 1, the network device configures non-coherent precoders and/or full coherent precoders and/or partial coherent precoders for the terminal equipment.

7. The apparatus according to claim 6, wherein the non-coherent precoders and/or the full coherent precoders and/or partial coherent precoders are indicated by one or more codepoints of the transmission precoding matrix indication field in the downlink control information.

8. The apparatus according to claim 7, wherein the number of first transmission precoding matrix indication fields indicating the non-coherent precoders is the same as the number of second transmission precoding matrix indication fields indicating the full coherent precoders, and/or a length of a first transmission precoding matrix indication field indicating the non-coherent precoders is the same as a length of a second transmission precoding matrix indication field indicating the full coherent precoders.

9. The apparatus according to claim 7, wherein one or more code points of the transmission precoding matrix indication field are used to indicate the full coherent precoders.

10. The apparatus according to claim 1, wherein for a terminal equipment with a precoder type being a partial coherence and with four antenna groups, the terminal equipment supports the full power mode 1, and
the network device configures non-coherent precoders, or partial coherent precoders, or full coherent precoders, or partial coherent precoders and full coherent precoders for the terminal equipment.

11. The apparatus according to claim 10, wherein the partial coherent precoders and/or the full coherent precoders are indicated by one or more codepints of the transmission precoding matrix indication field in the downlink control information.

12. The apparatus according to claim 11, wherein the number of third transmission precoding matrix indication fields indicating the partial coherent precoders is the same as the number of second transmission precoding matrix indication fields indicating the full coherent precoders, and/or a length of a third transmission precoding matrix indication field indicating the partial coherent precoders is the same as a length of a second transmission precoding matrix indication field indicating the full coherent precoders.

13. The apparatus according to claim 11, wherein one or more code points of the transmission precoding matrix indication field are used to indicate the full coherent precoders.

14. The apparatus according to claim 1, wherein for a terminal equipment with a precoder type being a partial coherence and with two antenna groups, the terminal equipment supports the full power mode 1,
the network device configures non-coherent precoders, or partial coherent precoders, or full coherent precoders, or partial coherent precoders and full coherent precoders for the terminal equipment.

15. The apparatus according to claim 14, wherein the partial coherent precoders and/or the full coherent precoders are indicated by one or more codepoints of the transmission precoding matrix indication field in the downlink control information.

16. The apparatus according to claim 15, wherein the number of third transmission precoding matrix indication fields indicating the partial coherent precoders is the same as the number of second transmission precoding matrix indication fields indicating the full coherent precoders, and/or a length of a third transmission precoding matrix indication field indicating the partial coherent precoders is the same as a length of a second transmission precoding matrix indication field indicating the full coherent precoders.

17. The apparatus according to claim 15, wherein one or more code points of the transmission precoding matrix indication field are used to indicate the full coherent precoders.

18. A precoding configuration apparatus, configured in a network device, the apparatus comprising:
a receiver configured to receive first information indicating the number of antenna groups supported by a terminal equipment and second information indicating whether a full power mode 1 is supported by the terminal equipment; and
a transmitter configured to transmit precoding configuration information for indicating a precoder type which is determined by the network device according to the first information and the second information, and
wherein the transmitter is further configured to transmit downlink control information including a transmission precoding matrix indication field indicating a value in one or more values which are indicated according to the precoding configuration information.

19. The apparatus according to claim 18, wherein for a terminal equipment with a precoder type being a full coherence, the terminal equipment at least supports the number Ng of antenna groups to be equal to 1, and the terminal equipment also supports the number Ng of antenna groups to be at least one or any more of 2, 4 or 8;
for a terminal equipment with a precoder type being a partial coherence and with two antenna groups, the terminal equipment at least supports the number Ng of antenna groups to be equal to 2, and the terminal equipment also supports the number Ng of antenna groups to be at least one or any more of 4 and 8;
for a terminal equipment with a precoder type being a partial coherence and with four antenna groups, the terminal equipment at least supports the number Ng of antenna groups to be equal to 4, and the terminal equipment also supports the number Ng of antenna groups to be 8; and
for a terminal equipment with a precoder type being a non-coherence, the terminal equipment at least supports the number Ng of antenna groups to be equal to 8.

20. A communication system, comprising:
a terminal equipment, capable of supporting an 8Tx uplink transmission, configured to report first information indicating the number of supported antenna groups and second information indicating whether a full power mode 1 is supported by the terminal equipment; and
the network device configured to transmit precoding configuration information for indicating a precoder type which is determined by the network device according to the first information and the second information, and
wherein the network device is further configured to transmit downlink control information including a transmission precoding matrix indication field indicating a value in one or more values which are indicated according to the precoding configuration information.
